(19) United States
(12) Patent Application Publication
(10) Pub. No.: US 2009/0323031 A1
(43) Pub. Date: Dec. 31, 2009

(54) CANDLELIGHT IMAGE PROJECTING APPARATUS AND METHOD

(76) Inventors: SHLOMO HAIM ADLER, Pikesville, MD (US); ELAD REFAEL ADLER, Jerusalem (IL)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/435,495

(22) Filed: May 5, 2009

Related U.S. Application Data
(60) Provisional application No. 61/076,383, filed on Jun. 27, 2008.

(51) Int. Cl. G03B 21/00

(52) U.S. Cl. 353/62; 353/121

(57) ABSTRACT

A candlelight image projecting apparatus and method preferably includes structure and/or function whereby a panel has a shadow-producing image disposed thereon, and a base is coupled to the panel. Preferably, the base is configured to hold a candle spaced from the panel such that a top of the candle flame is always below a top of the shadow image to cause a top of the shadow image to always be projected above the top of the panel. The base may be configured to hold an outer surface of a candle from 1-3 inches from the panel and so that the top of the candle flame is below a top of the shadow-producing image to cause an enlarged shadow to be projected upward from the panel.

This application claims priority benefit of U.S. Provisional Patent Application No. 61/076,383, filed Jun. 27, 2008, the entire contents of which are incorporated herein by reference.

### FIELD OF THE INVENTION

The present invention relates to the field of projecting one or more images from a candle-holding device.

### BACKGROUND OF THE INVENTION

The present invention relates to a candlelight image projecting apparatus and method, which projects images comprising personal portraits, text, logos, icons, etc. on a wall or other object. Such candlelight devices are popular in restaurants, improve the ambiance in lounges, and are used for commemorating events and also in advertising.

Currently there exist candlelight devices with fixed designs applied to them so that when a candle is placed into a central holder, the candlelight is seeing through the visible part of the design so as to cast a shadow of the specific design on a nearby wall or other object. In another technique, a translucent candle body material has a decorative design embedded therein, and the candlelight casts the decorative design to create aesthetic shapes and shadows. Other devices include lamp-based shadows projecting for displaying images and text. See for example the light-projecting devices in U.S. Patent Publication No. 2006/0172241. However, no known designs provide for a stable, continuous projection of a pleasing image from candlelight.

### SUMMARY OF THE INVENTION

It is an object of the present invention is to provide a candlelight image projecting apparatus and method that is useful to commemorate personal, community, or national events, yet is aesthetically appealing. Such a candlelight image projecting apparatus and method may also be used as a means to remember our loved ones as well as national and international religious, sports, and theater figures. The features of the present invention may also enable users to easily customize an image to be cast as a shadow on a nearby wall or other object. The features of the present invention may also enable users to easily change the image.

According to a first aspect of the present invention a candlelight image projecting apparatus includes a panel having a shadow-producing image thereon, and a base coupled to the panel. Preferably, the base is configured to hold a candle spaced from the panel such that a top of the candle flame is always below a top of the shadow image to cause a top of the shadow image to always be projected above the top of the panel.

According to a second aspect of the present invention a candlelight image projecting apparatus includes a panel having a shadow-producing image thereon, and a base onto which the panel is mounted. Preferably, the base is configured to hold an outer surface of a candle from 1-3 inches from the panel and so that the top of the candle flame is below a top of the shadow-producing image to cause an enlarged shadow to be projected upward from the panel.

According to a third aspect of the present invention a method of projecting a candlelight image onto a surface includes (i) providing a non-flammable panel having a shadow-producing image thereon; (ii) disposing an outer surface of a candle on a base and at a distance from said panel; and (iii) causing light to be projected from the candle in a manner to project a shadow of the image upward and enlarged onto a surface at a distance from said panel.

### BRIEF DESCRIPTION OF THE DRAWINGS

The advantageous features according to the present invention will be more readily understood from the following description of the Detail Description of the Presently Preferred Embodiments taken in conjunction with the Drawings which show:

FIG. 1 is a perspective view of the candlelight image projecting apparatus, according to one embodiment of the invention;

FIG. 2 is a perspective view of the candlelight image projecting apparatus, featuring a replaceable image frame, according to another embodiment of the invention;

FIG. 3 is a perspective view of the candlelight image projecting apparatus, featuring a replaceable panel, according to yet another embodiment of the invention;

FIG. 4 is a top view of the candlelight image projecting apparatus having a replaceable panel, according to the FIG. 3 embodiment of the invention;

FIG. 5 is a perspective view of the base of the candlelight image projecting apparatus having a replaceable panel, according to the FIG. 3 embodiment of the invention;

FIG. 6a is a front view of the replaceable panel, according to the FIG. 3 embodiment of the invention;

FIG. 6b is front view of another replaceable panel, according to the FIG. 3 embodiment of the invention;

FIG. 7 is a schematic view of a mockup of the candlelight image projecting apparatus, according to an embodiment of the invention;

FIG. 8 is a perspective view of a base with an enlarging and focusing path for the candlelight image projecting apparatus, according to an embodiment of the invention;

FIGS. 9A, 9B, and 9C are perspective views of particularly preferred embodiments of the invention;

FIGS. 10A, 10B, and 10C are perspective views of translucent embodiments of the invention;

FIGS. 11A, 11B, and 11C are perspective views of other embodiments of the invention;

FIGS. 12A and 12B are schematic side views of light ray projection according to the described embodiments;

FIGS. 13A and 13B are schematic side views of light ray projection according to the described embodiments;

FIGS. 14A, 14B, 14C, and 14D are side, perspective, and plan views of other embodiments of the invention;

FIG. 15 is a perspective view of another embodiment of the invention;

FIGS. 16A and 16B are perspective views of a floating embodiment of the invention;

FIGS. 17A and 17B are schematic and detailed side views of light ray projection according to an embodiment of the invention;

FIG. 18 is a schematic side view of light ray projection according to a vertically-curved panel embodiment of the invention; and

FIGS. 19, 20, and 21 are schematic light ray projection views of possible reflections in various embodiments of the invention.

FIGS. 22A, 22B, 22C, 22D, 22E, 22F, and 22G show the cut-out image drawing process in various embodiments of the invention.

FIG. 23 depicts a flowchart of the cut out process in various embodiments of the invention.

FIG. 24 shows a vector image in various embodiments of the invention.

FIG. 25 depict a flowchart of the adjustment process in various embodiments of the invention.

### DETAILED DESCRIPTION OF THE PRESENTLY PREFERRED EMBODIMENT

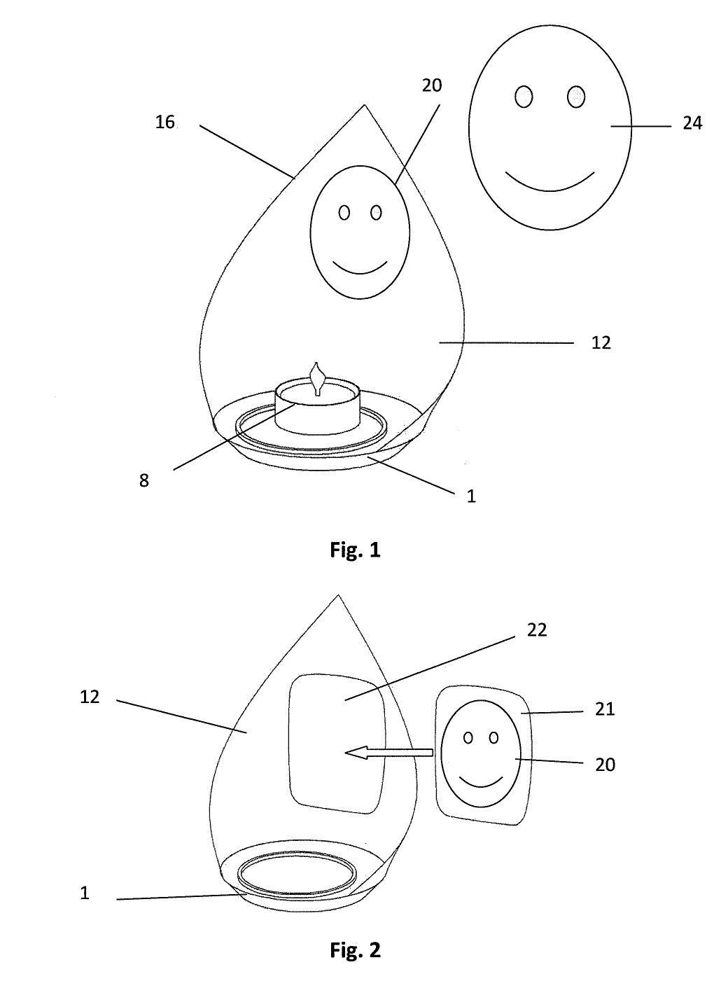

The embodiment of FIG. 1 includes a base 1 in which a candlelight source 8 is placed thereon, and a panel 12 having an image 20 composed of picture, text, or icon or any combination, printed, carved, cut, or otherwise placed thereon. The panel 12 may be integral with the base 1, or screwed, welded, glued, or otherwise attached thereto. The image 20 may be cut out directly from panel 12, or it may be placed on a transparent or translucent surface that is affixed to an opening in the panel 12, depending on the effect desired. The outer surface of the candlelight source 8 is preferably placed at a distance of from 1-4 inches (more preferably 1-3 inches) from the panel, and so that the top of the flame is below or adjacent the top (or, more preferably, the bottom) of the image 20, so that the image projects an enlarged shadow 24 of image 20 upward onto a wall or other object located behind the panel 12. The panel 12 may have a pleasing outline or shape, such as shape 16.

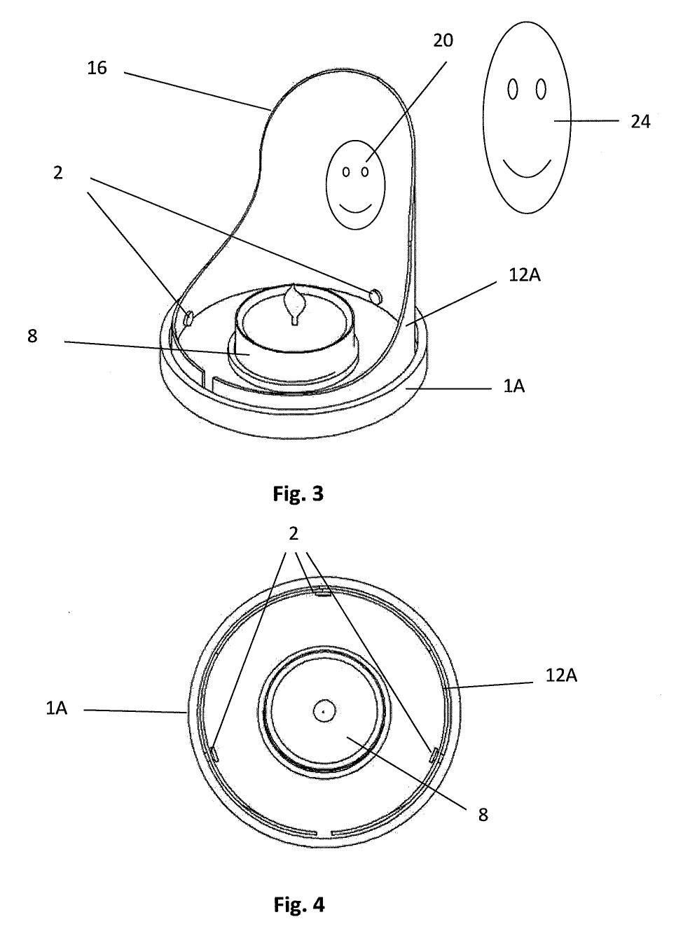

In another embodiment of the present invention, as illustrated in FIG. 2, the panel 12 has a removable/replaceable frame 21 which may be changed in order to change the projected image. The frame 21 may be hinged to the panel 12, or retained therein by tongue-and-groove structure, slots, or by adhesives, etc. The image 20 may be printed, carved, or cut from frame 21, or placed on a transparent or translucent surface that is affixed to the frame 21. The panel 12 thus has an opening or niche 22 in which frame 21 may be placed. Frame 21 may be constructed of plastic, transparency film, or a sheet metal, on which image 20, may be printed, carved, or cut therefrom.

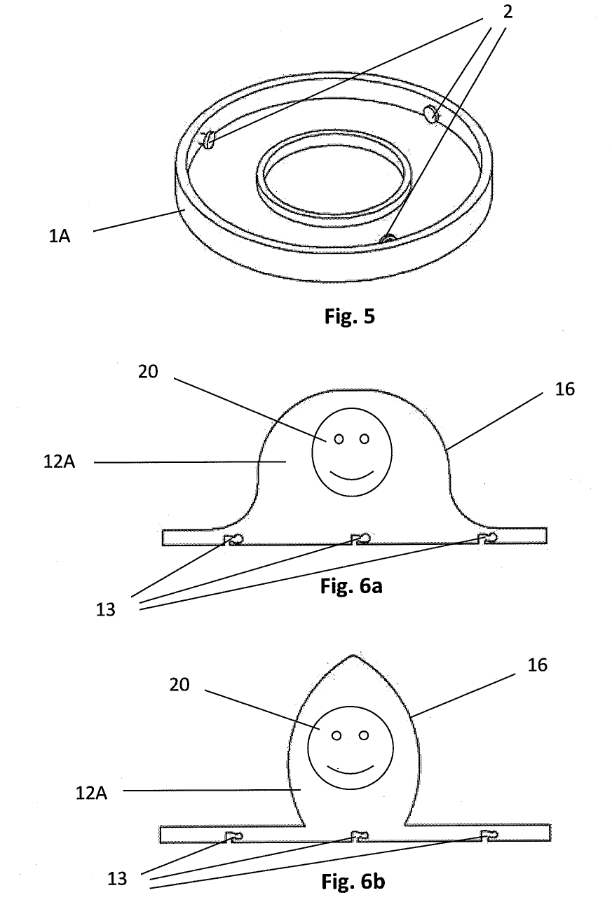

In another embodiment of the invention, as illustrated in FIG. 3, the candlelight image projecting apparatus includes a base 1A on which a candlelight source 8 is placed, and a replaceable panel 12A having an image 20 printed, carved, or cut therefrom. As FIG. 3 illustrates, the base 1A includes fasteners 2 into which the replaceable panel 12A is mounted. The fasteners 2 may include welding, screws, tongue-and-groove, slots, adhesives, etc. As illustrated in FIGS. 5, and 6A and 6B, replaceable panel 12A preferably has shaped slots 13 which are couple to stud fasteners 2 having large, flat heads to lock panel 12A to base 1A. As FIGS. 6A and 6B also illustrate, the replaceable panel 12A is preferably constructed of a thick plastic film upon which the image, such as image 20, may be printed, drawn, carved, stamped, cut, or otherwise placed thereon. In another embodiment of the invention, the replaceable panel 12A is constructed of a sheet metal including, but not limited to, tin, aluminum, steel, brass, copper, nickel, and/or silver, upon which the image, such as image 20, may be shaped by cutting or carving therefrom.

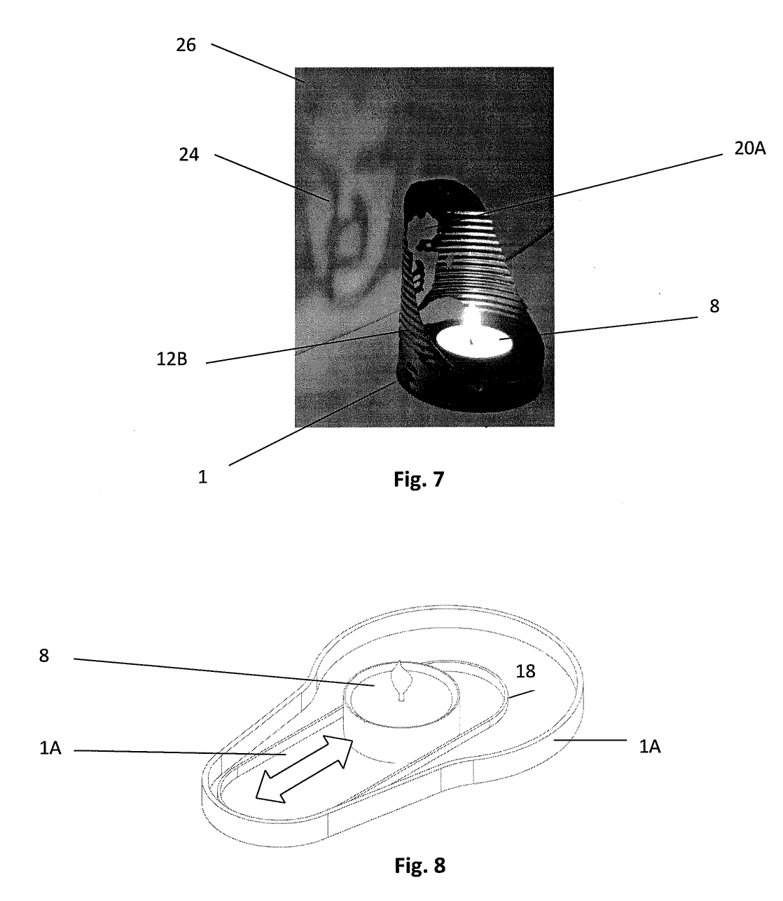

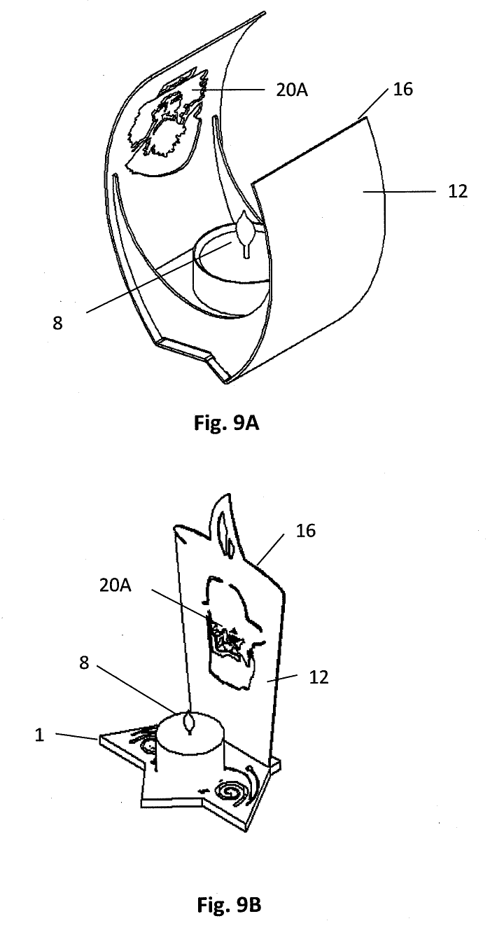

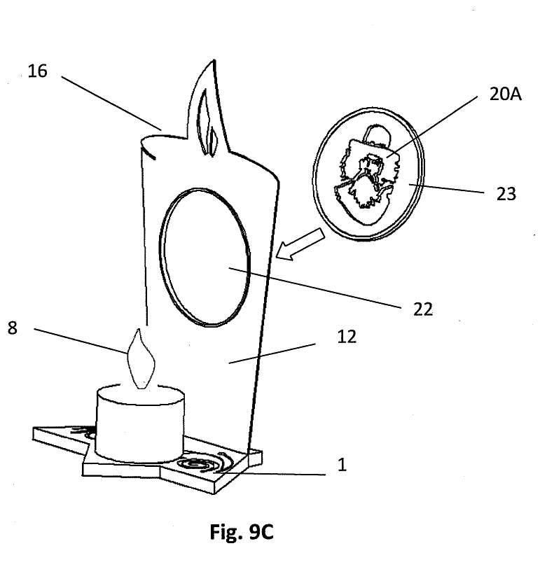

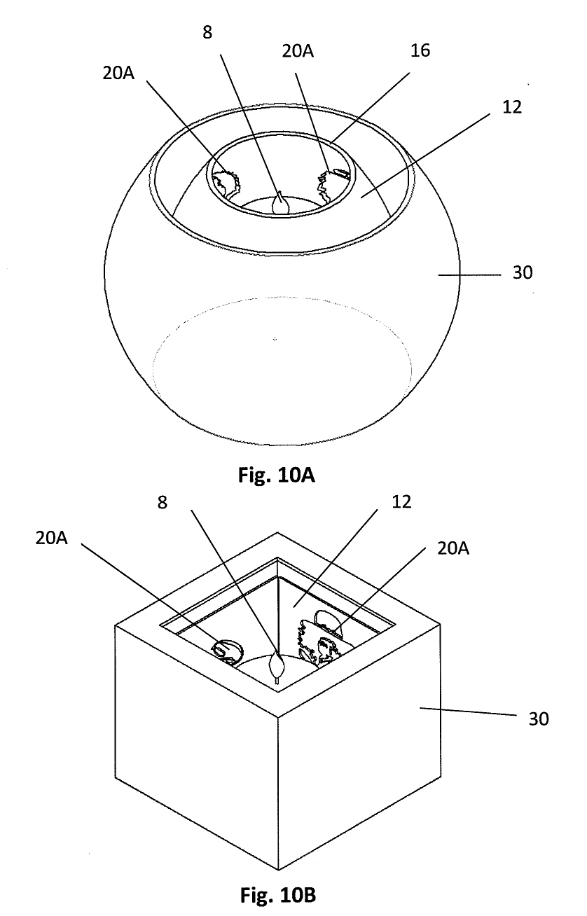

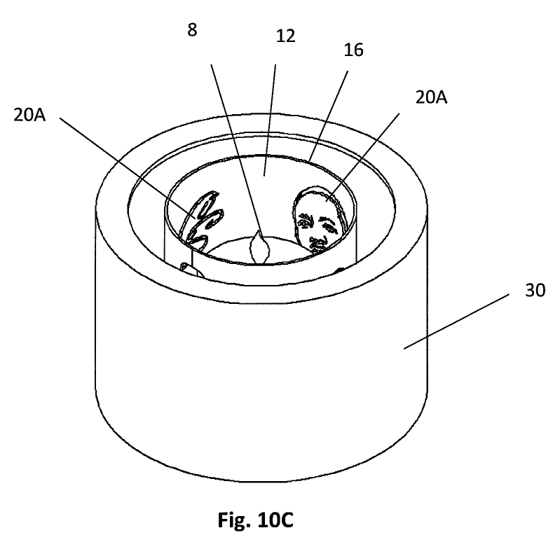

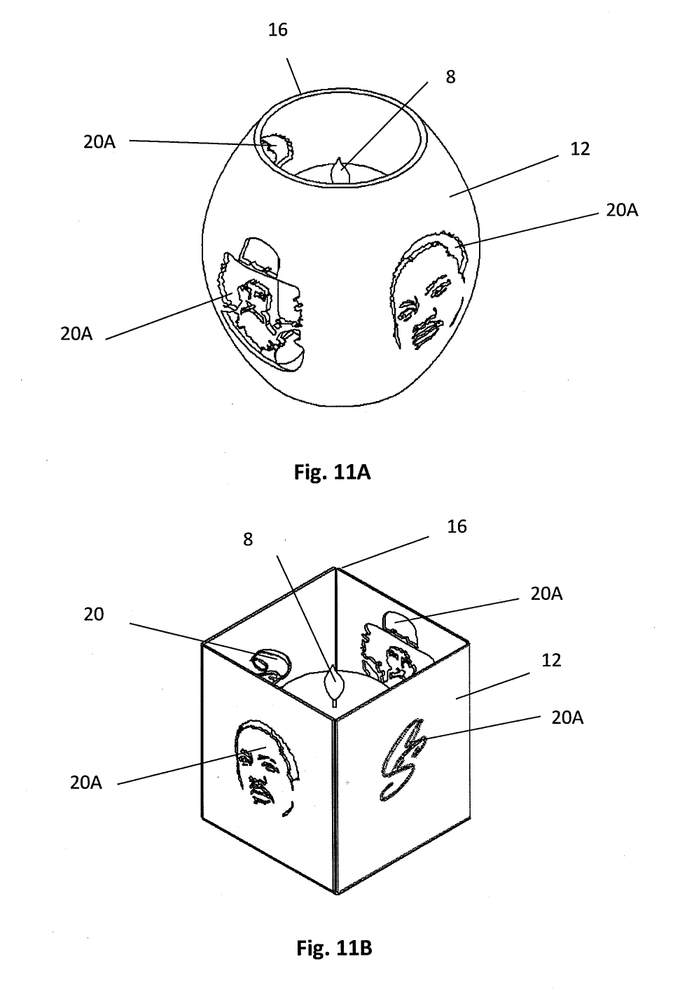

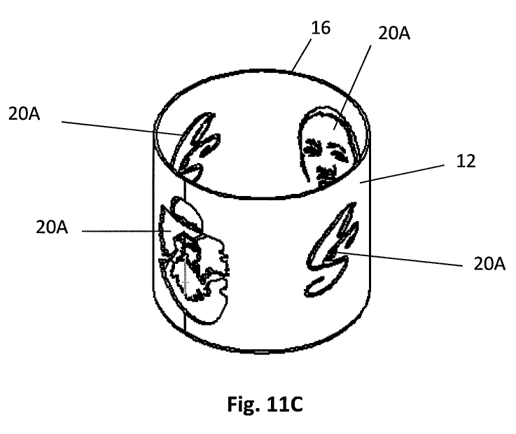

It will be appreciated that candlelight source 8 may be a real candle or any artificial candle including, but not limited to, one or more white or colored LEDs, or any equivalent light source, either battery or electrically powered and/or controlled. An electric candlelight source may be controlled to flash, display continuous light, flicker as a natural candle, etc., in the manner of commercially available small LED flash lights. It will also be appreciated that the candlelight image projecting apparatus along with its components may be formed in any geometrical shape, design, and decoration, and is not limited to the shapes and profiles appearing in FIG. 1, FIG. 2, FIG. 3, FIG. 6, FIG. 7, FIG. 8, FIG. 9, FIG. 10, and FIG. 11. It will be further appreciated that the components of the candlelight image projecting apparatus may be provided in different colors and textures. The embodiments described above may be user-assembled, user-replaceable, and user-maintainable. In a further embodiment, the image 20 may be user-customizable, such as where the image 20 may be drawn, sketched, or otherwise imprinted upon a clear or colored transparent or translucent frame 21 or equivalent panel. Of course, the image 20 may be user-printable on a user's personal computer and printer.

As shown in the embodiment of FIG. 7, the candlelight image projecting apparatus may use the candle light source 8 to shed light on panel 12B, thereby the light passes through visible cut out part of image 20A, casting an enlarged shadow of image 20A on a wall or other object 26 located behind panel 12B. The cast shadow provides a special intimate way to commemorate very special events or beloved ones. In this embodiment, the top of the candle flame is somewhat above the bottom of the image 20A, but still below the center thereof in order to raise the image above base 1 level to provide an enlarged but realistic image 24 on the wall positioned above the base 1 level. Furthermore, the flickering movement of the flame of said candlelight 8 causes said enlarged shadow 24 to flicker and move correspondingly, providing a lively shadow scene. The customizable nature of the present invention, as in certain of the above-described embodiments of the invention, lends itself to multiple uses such as to memorize beloved, national memorial days, or to celebrate special holydays, weddings, romantic and personal events, in a very exceptional atmosphere. It will be appreciated that multiple candlelight image projecting apparatuses may be used to projecting multiple or combined images 24. For example, three such apparatuses may be used to project the Three Magi in a Christmas Scene.

In a further embodiment illustrated by FIG. 8, the candlelight 8 can be moved across the base 1A freely or in a racetrack-like slot 18, to enlarge or sharpen shadow 24. The slot 18 may be inclined with respect to a horizontal surface to provide additional adjustment between the candle and the panel, thus providing the ability to fine-tune to the projected image.

A light projector typically comprises a light source, a parabolic reflector, and a condensing lens (or a Fresnel lens), which collimates the light into parallel beams and directs them toward the image so that the beams are substantially perpendicular to the image on any given point of the image. Another lens may be disposed in front of the image to focus the beams, depending on the distance between the projector and the projection spot.

A candlelight projector without reflectors and lenses, in contrast to the typical projector described above, poses many challenges. Its light intensity is weak, unfocused, and not collimated, resulting in light rays which propagate in many directions and angles. When a wax-based candle is used, the flame descends when the wax burns, resulting in continuous changes in the position of the light source. When a cut-out image is used, the challenges are related to the thickness of the material and the complication of creating detailed features on a non-contiguous material.

The candlelight image projecting apparatus has two main configurations (but is not limited thereto), with many variations. One configuration is aimed at projecting light-and-shadow images to an outside object like wall, table plate, closet, and the like (hereby “Wall model”; see FIGS. 9A and 9B). The second configuration is aimed at projecting the image onto a translucent sheath, panel, or object 30, on which the image is projected and is visible on its opposite side (hereby “translucent model” see FIGS. 10A, 10B, and 10C). In the translucent model, the image is preferably in reverse position to the desirable projected image. Both models can project several images similar or dissimilar to any direction. In addition, the panel 12 and sheath 30 can be shaped in any design and form (round, cubic, sphere, sculpture and etc.), which may be similar or dissimilar.

Candlelight position and intensity are notable variables in forming apparatus according to the present invention. The wall version is preferably placed just several inches (2″-10″) from the projection spot in order to be most effective. The reason is that the intensity of candlelight is low and declines inversely to the square of the distance from the light source, which means that as the distance doubles, the light is decreasing by a factor of ¼ (inverse-square law). The size of the projected image is another notable variable. Projected image size can be changed by moving the image panel (in the beam-axis direction) relative to the projection spot, and/or moving the candle relative to the image panel. The magnification factor of any given point on the image, in case of a vertical flat projection spot and image panel, is equal and is given by:

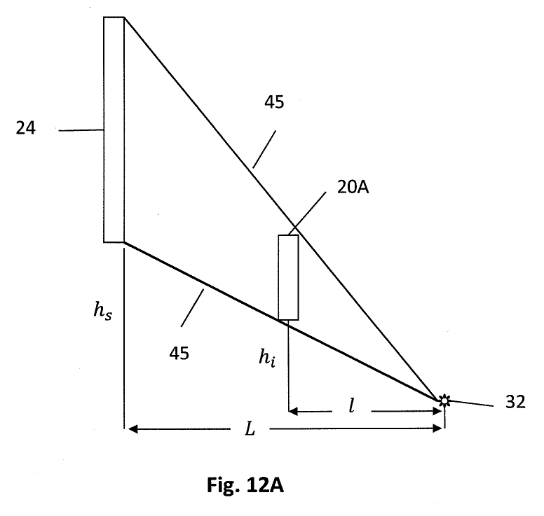

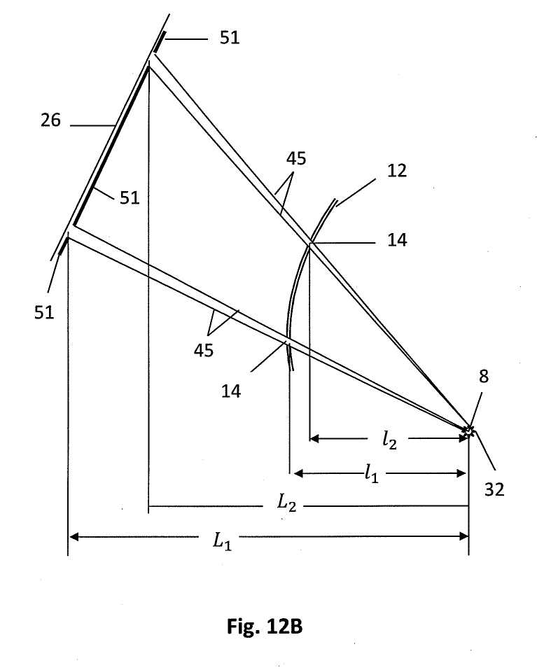

M=L/l (1)

where M is the magnification factor, L is the horizontal distance between the image panel and the projection spot, and l is the horizontal distance between the light source and the image panel (see FIG. 12A). In case of other shapes rather than flat vertical positioned projection spot and image panel, each image point 14 may have different L and l (see in FIG. 12B, L₁,l₁ and L₂,l₂, respectively) and therefore different magnification factor which means a distorted image. The bellow described Magnification Adjusting process takes care of it. The image projecting apparatus will have a range of versions with different degrees of freedom to move L and/or l in order enlarge or sharpen the image.

Image Positioning is another notable design feature. Proximity to the projection spot is preferable to avoid interrupting the light rays 45 by intervening objects and walking people. Hence, this proximity might make the image invisible unless one gets very close to the candlelight projector. Therefore, placing the image 20 in a higher position relative to the light source 32 causes the projected image 24 to rise (see FIG. 12A). The raising factor is given by:

hₛ=(L/l)×hᵢ=M×hᵢ (2)

where hₛ is the projected image bottom heights relative to the light source center, M is the magnification factor, and hᵢ is the image panel height relative to the light source center. The image projecting apparatus will have a range of versions with different degree of freedom to change the magnification factor (M, thru moving L and/or l), and the image height (hᵢ) in order raise the projected image position. Positioning the image at a higher level position relative to the center of the light source has pros and cons. The pros include: 1) Raising the image position; 2) Avoiding candle body interference to light rays; 3) Prolonging exposure time to candle light in which the flame descends under the surface of a nontransparent embedded or nontransparent container; and 4) Eliminating the blurring effect (see the shutter apparatus discussion below) at the upper edges of shadowed features as the light rays arrive at these edges in an angle lower than 90 degrees. The cons include: 1) A larger angle deviation between the image's lower and upper parts; and 2) Enhancing the blurring effect at the lower edge of the shadowed features as the light rays arrive these edges in an angle greater than 90 degrees. According to the preferred embodiments, it is believed to be easier to deal with the blurring effect that is caused by the lower part of the light source, as will be described below.

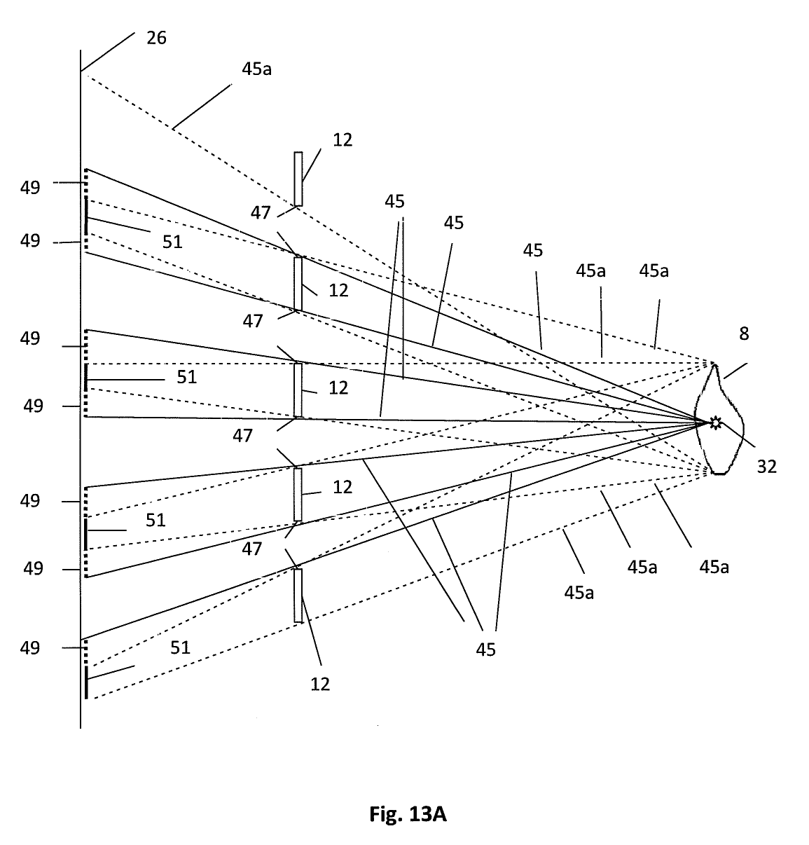

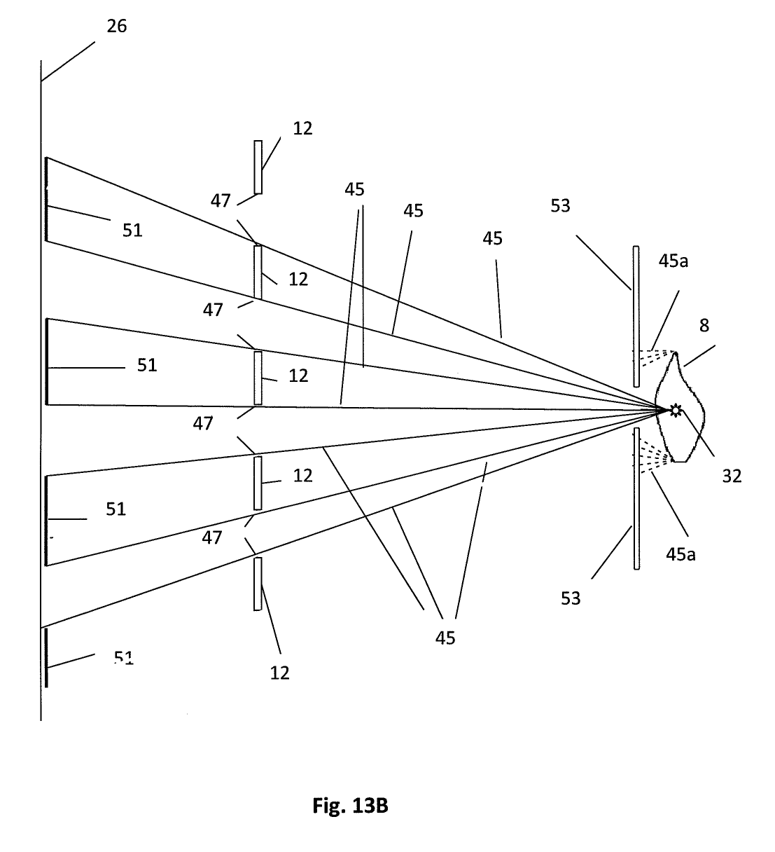

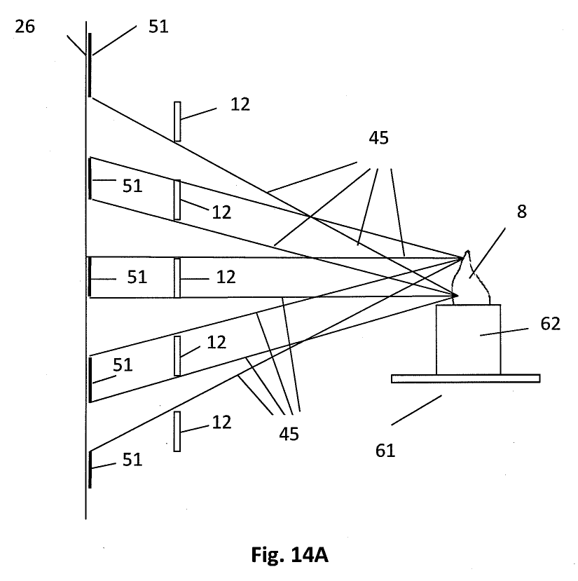

The shutter apparatus is also an important feature to consider during design and operation of the preferred embodiments. Flame or flame imitation (whether it is one or more bulbs or one or more LEDs) is of an unfocused nature. Each point of an unfocused light source 8 is, in fact, another source of light ray emission. If light rays 45a arrive at a light and shadow border line 47 (typically, the front face of the panel 12) from different angles than the light rays 45 radiating from the center point of the source of light 32, the result is blurring border lines 49. This happens since these light rays 45a arriving at places which are supposed to remain dark as they represent shadow 51 (see FIG. 13A). The number of light rays arriving from different angles at any given point of the image increase directly with the size of the light source. Therefore, decreasing the size of the light source decreases the blurring effect. A shutter apparatus 53 (see FIG. 13B), like the diaphragm described in U.S. Pat. No. 1,972,123 (incorporated herein by reference), which is referred to as “securing point sources of light by use of an opaque diaphragm having an opening therein for defining, collecting or concentrating the light rays”, can serve for the purpose of restricting or minimizing the size of the light source. As seen in FIG. 13B shutter apparatus 53 blocks unwanted light rays 45a. However, according to this patent, the implementation of the diaphragm is by fabric, which is not presently preferred for candlelight. Furthermore, this patent does not completely solve the problem of the light source (flame) descending in wax candles, or the problem of a light source which placed considerably below the image for raising the projected image above the base or top of the candlelight image projecting apparatus.

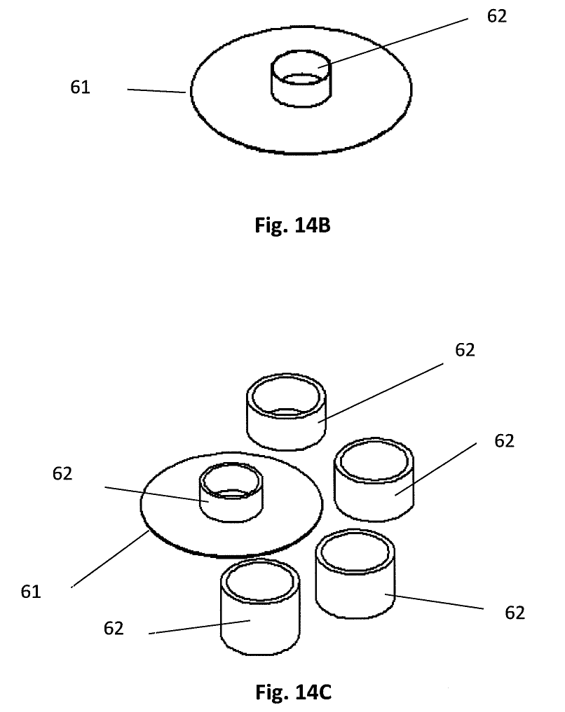

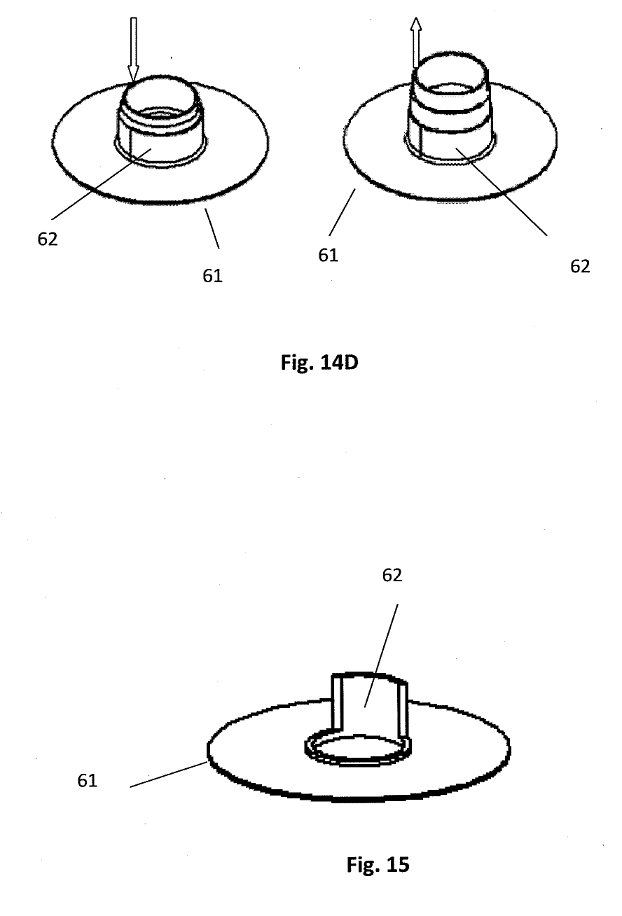

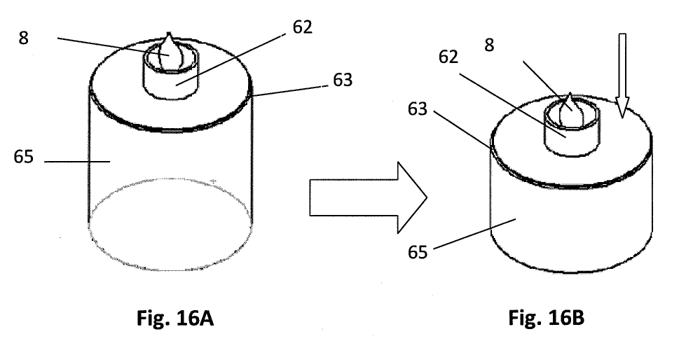

A solution to the above-posed challenges may be provided by a crown shutter apparatus 61, preferably made out of inflammable material, which is placed on the light source in a way that blocks the lower part of the light source from shedding light on the image. The degree of blockage depends on the vertical height of the shutter walls 62. The shutter wall 62 can comprise one or more plates, or one or more cylinders, or telescopic cylinders which surround the light source. Their height can be adjusted to fit a particular light source in order to get the desired light exposure for the sharpest image possible, as in FIGS. 14A, 14B, and 14C. The shutter wall 62 can also comprise a partial wall or plate which blocks merely the side facing the image (FIG. 15) thus, a full flame can been seen from its sides and behind. As for wax candles with flames that descend as the wax burns, a floating crown shutter apparatus 63 will do the job (see FIGS. 16A and 16B). The floating crown shutter 63 is similar to the above-described crown shutter 61 except that it is preferably made out of light weight, inflammable material (e.g., aluminum foil, glass, tin, titanium or similar material, alloys, or combination of materials). The floating crown shutter 63 is placed around the flame on the top of the wax 65. The light weight of the crown shutter 63 causes it to float over the wax and descend alongside the flame as the wax burns (as depicted in FIGS. 16A and 16B).

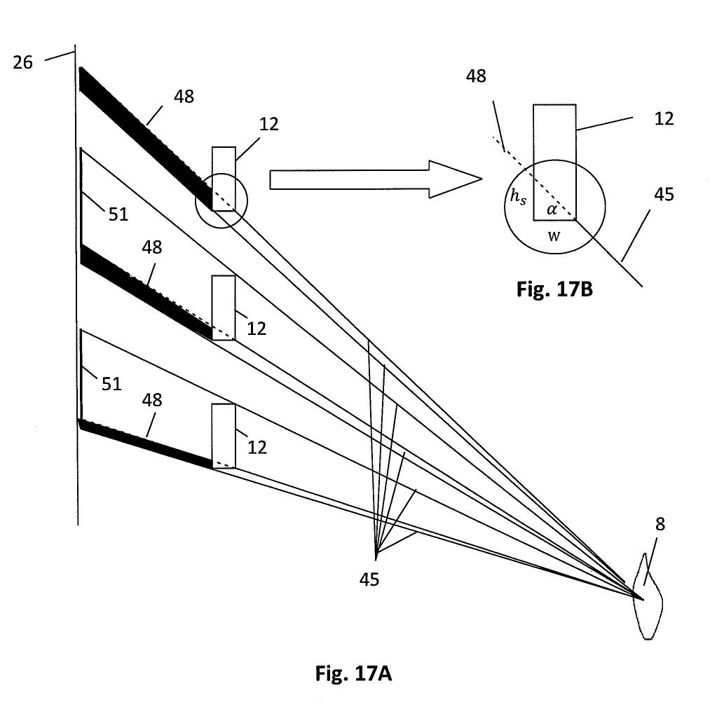

The image panel shape design provides for maximum creativity. Images of Religious Characters, Martin Luther King, Elvis Presley, Princes Diana, Barak Obama, etc. will obviously be popular. Formation of such shapes, however, is not trivial. The preferred configuration for a bare projector, without reflectors and lenses, is a focused light source which casts light toward a slim flat-shaped image to project it on a flat projection spot. However, this may not be strictly achievable as candlelight and candlelight imitation is far from being focused. Furthermore, when a cut-out image involved, if the light rays are not completely perpendicular to the image, the cut-out profile blocks some light rays 48, as seen in FIGS. 17A and 17B. The thicker the panel 12, out of which the image is cut, and the higher the angle a between the light rays and the image panel 12, the more that light ray blockage exists. To avoid the ray blockage, an additional cut may take place. For each image feature, the additional segment that should be cut out is given by:

hₛ=w×tan α (3)

where hₛ is the length of the segment that should be cut out, w is the image panel thickness, and a is the angle between the light rays radiating from the center point of the light source and the image features borders, as depicted in FIG. 17B. In order to avoid distortion, a thickness adjustment process which is described below is preferably carried out by extending the cut out area by hₛ for each cutting edge, in respect to its α. The problem is that it caused the resolution to decrease by hₛ thus, the ability to implement detailed images is accordingly diminished. In other words, if for a particular projector the minimum size for an image shadow point to be visible, on the projection spot is x, now it becomes x+hₛ. It means that images which consist of features that are smaller than x+hₛ will lose fidelity. The larger is hₛ, the lower the resolution that could be achieved.

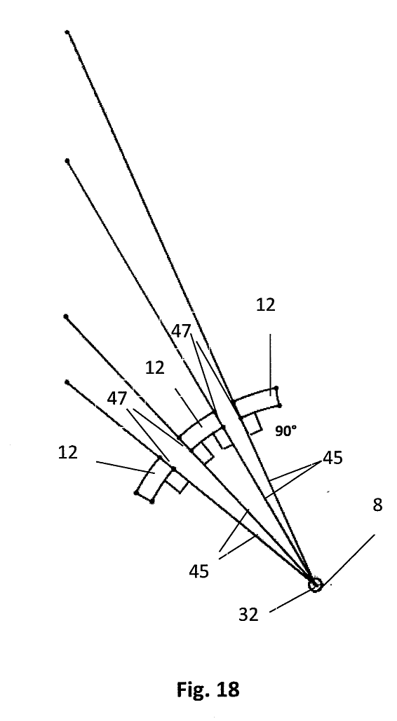

According to a preferred embodiment, a vertically curved image panel shape (e.g., FIG. 9A), concentric to the light source center point, is another alternative to deal with any imaging problems caused by the cut-out process described above. In vertical curved images, light rays arrive at each point on the image panel at right angles and therefore need no thickness adjustments (see FIG. 18). The vertical curve also has the advantage of raising the projected image on the wall, since its image panel vertical height is lower than a flat image with the same circumstances (e.g., the top of panel 12 in FIG. 9A may be vertically lower that the top of panel 12 in FIG. 1 given the same image 20 which is positioned at the same heights), and thus the entire apparatus will have a lower profile, as well keeping the light source closer to the best projection spot without hiding the projected image 24. The height ratio between a flat image panel 12 and a curved shape image panel 12, assuming l=r, is given by:

h_{f}/h_{c}=cos⁻¹ α (4)

where: l is the distance of the flat panel from the light source center point; r is the radius of the curved shaped panel which is preferably substantially concentric with the light source center point; h_{f} is the flat panel height; h_{c} is the curved panel height; a is the angle between the two edges of the angle opposite to h_{f} and h_{c}. Preferably, the curved shaped image is created using a magnification adjustment since each point on the curve may have a different magnification factor M as L and l parameters are different, respectively (see FIG. 12B). The adjustment process described below deals with this very issue.

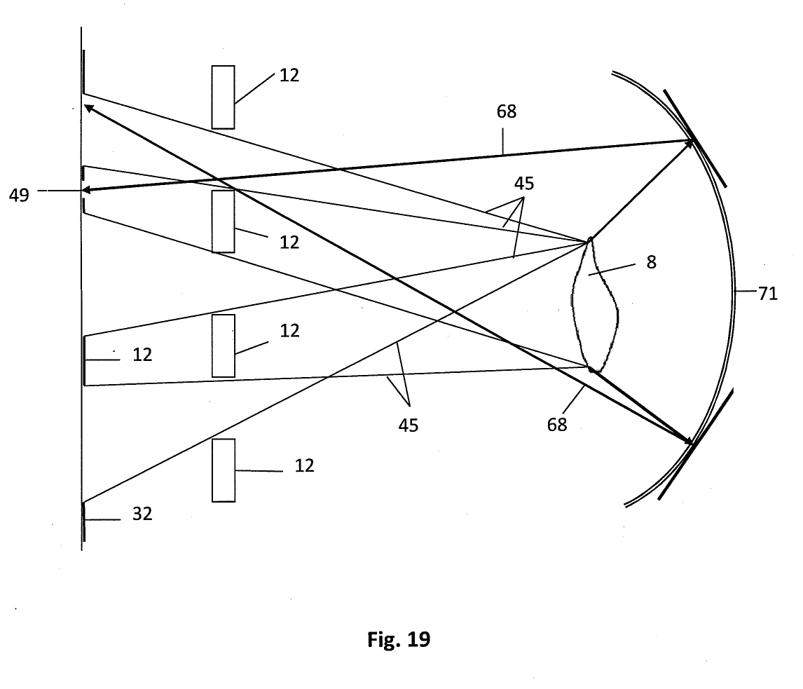

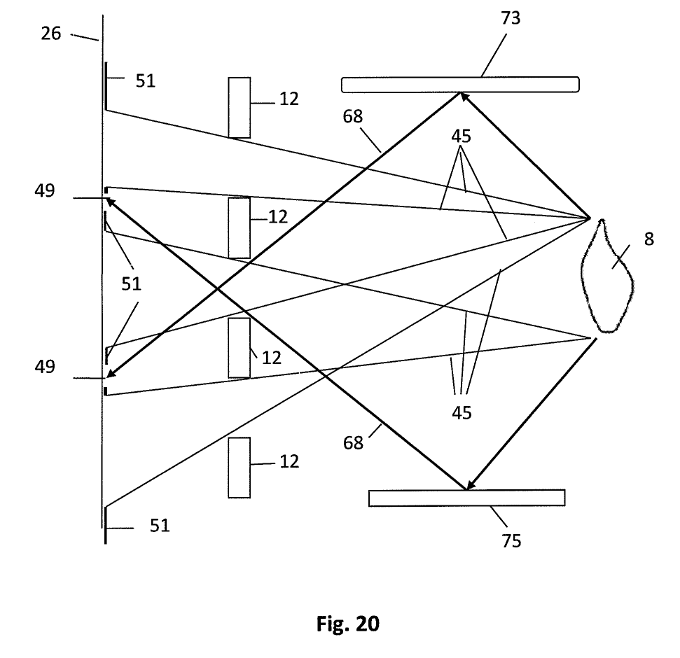

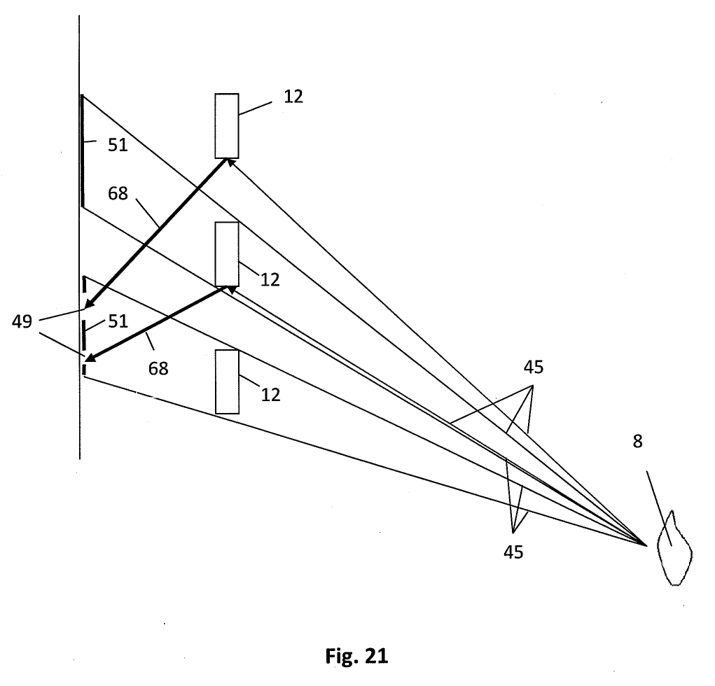

The design is constrained less by horizontal distortion since the candle is usually placed horizontally centered to the image. In that case, the horizontal distortions are small since the angles are far less acute and the light source is relatively focused as the candle flame tends to be in a parabolic shape with its height longer than its width. Even though, the adjusting process will deal with horizontal distortions as well. Unwanted reflections 68 are another source of distortion that is preferably avoided. Such reflections, for example, can be induced by a reflective area in the back of the light source 71 (see FIG. 19), by the top 73 or bottom 75 (see FIG. 20), and/or by the cut-out panel 12 itself (see FIG. 21). Such reflective distortions are preferably treated by a non reflective texture or coating on the reflective surface.

The cut-out image drawing process is not simple. One aspect of the present invention is to provide a candlelight image projecting apparatus to project a cut-out image, in a high-fidelity, high-definition fashion, on a nearby wall or other article, or onto a translucent object. Thus, the present invention preferably projects a shadow and light image of individual characteristics (e.g. an individual person, pet, companies' logo, universities' logo and the like) which should be recognizable by those who are familiar with them. There is, however, a challenge in preserving the fidelity of complex images in a cut-out image, which challenge does not exist in contiguous material such as paper, cloth, glass, transparency, and the like. The main image character features should be accurately revealed. These features are usually distinguished by fine lines which should be kept in the image. Yet, in most occurrences, there are multiple shadowed features which are isolated and should not be ignored. Therefore, it is apparent that these isolated “shadow islands” should be linked to the panel, in one way or another by “isthmus” that transform these islands into “shadow peninsulas”. Adding these isthmuses in the cut-out design, if not done properly, could badly affect the image fidelity, as they would add shaded areas in places which are supposed to light up.

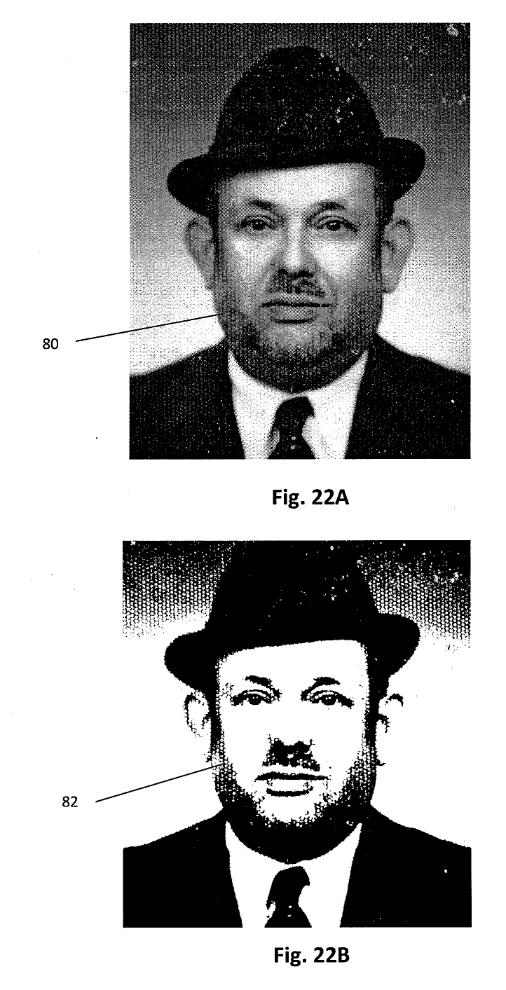

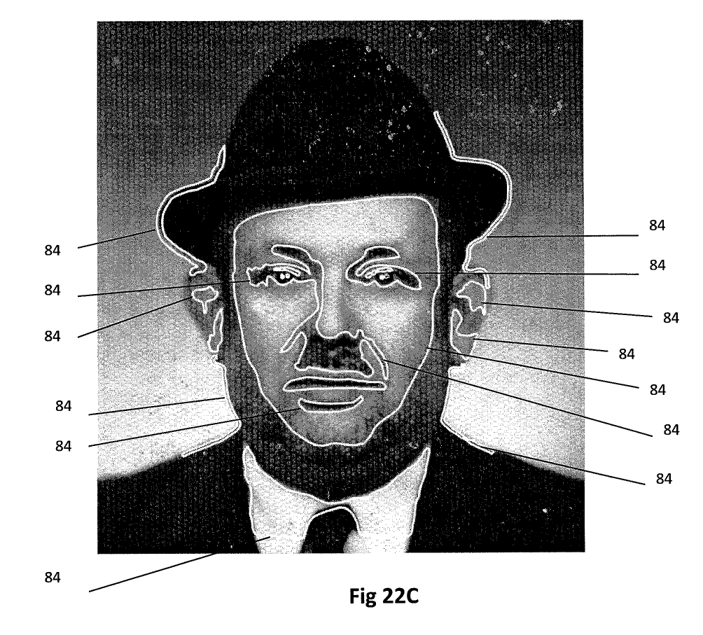

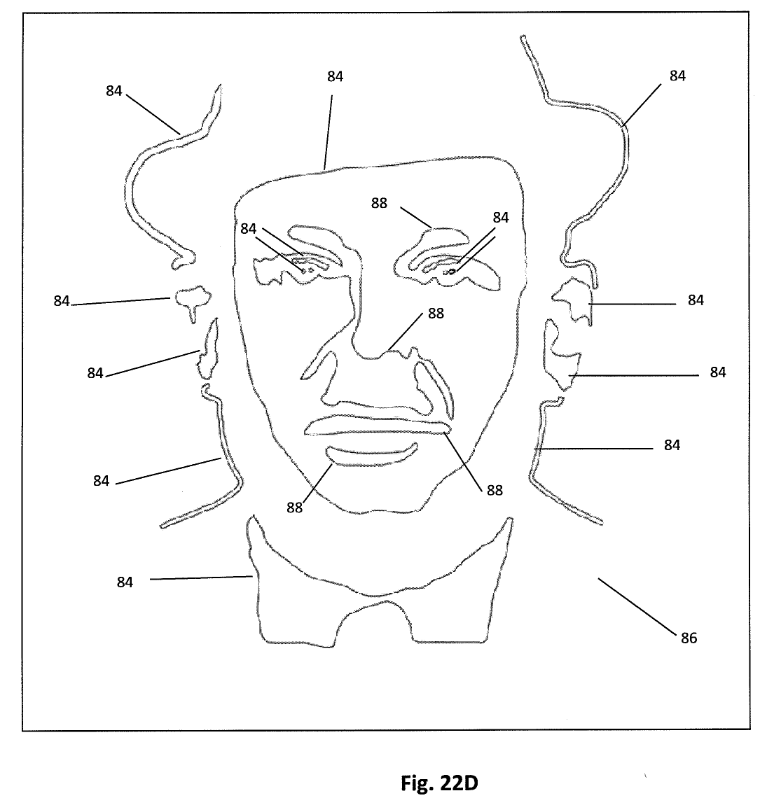

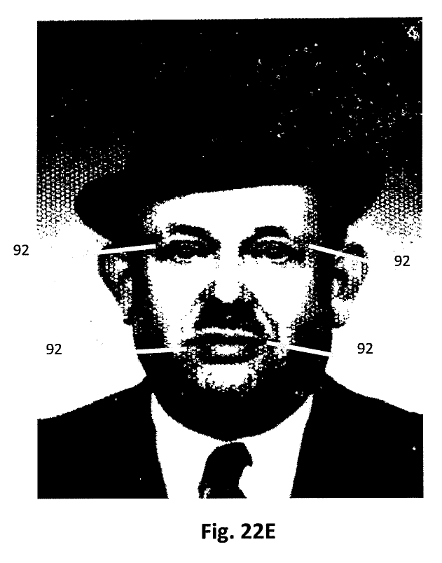

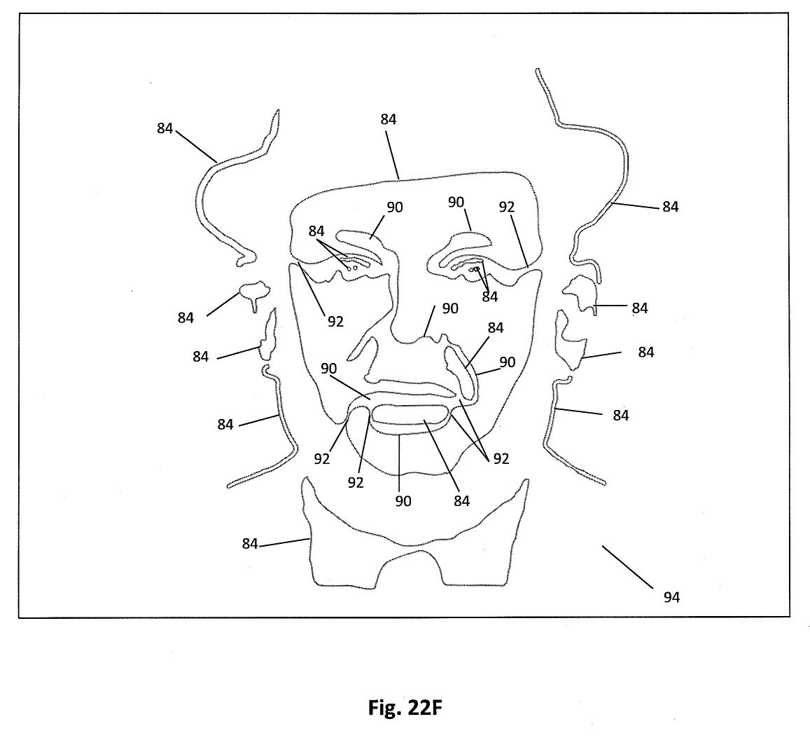

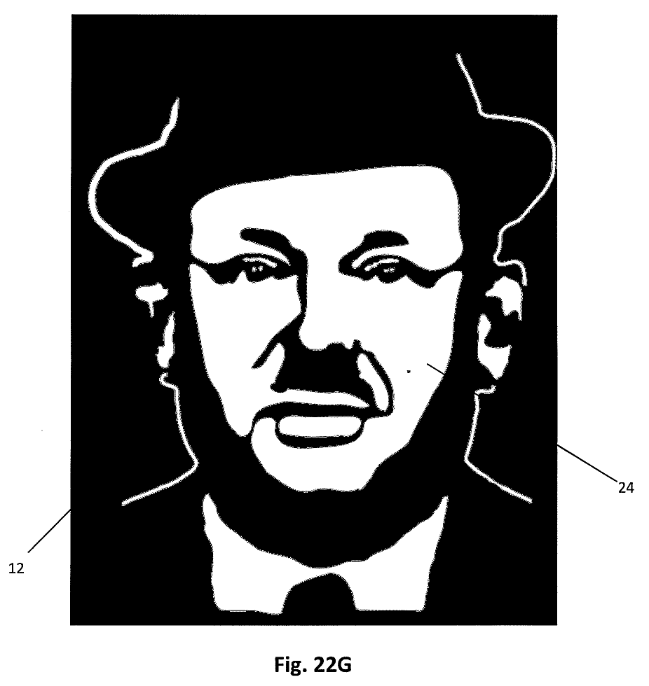

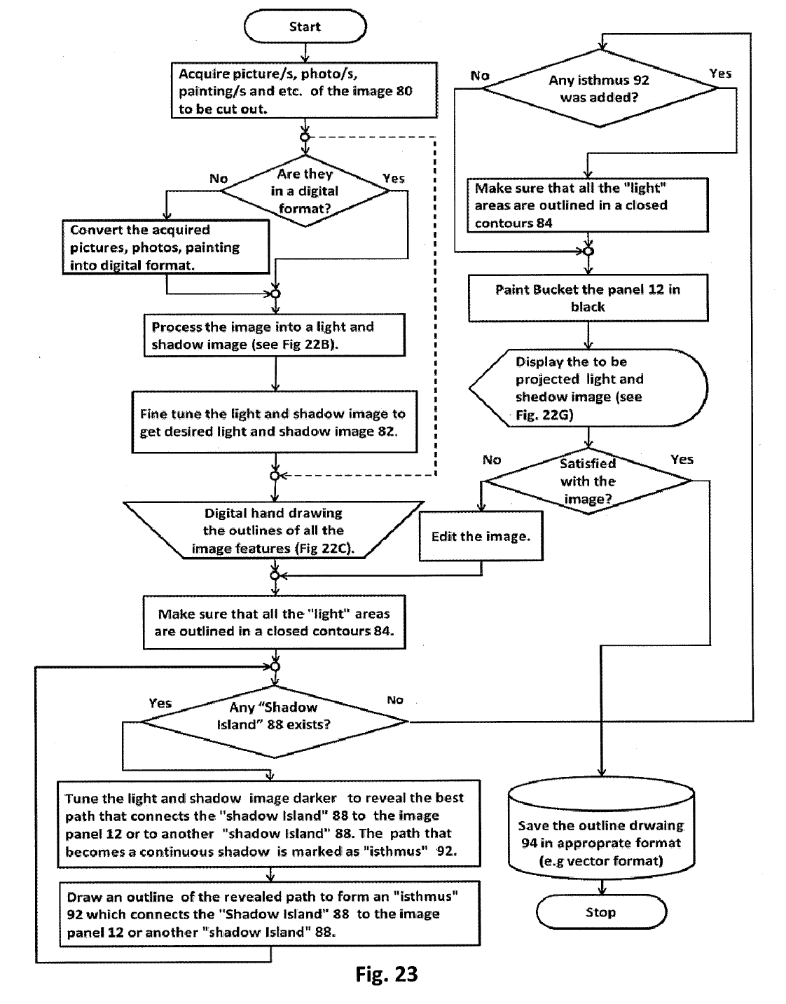

The following process was developed to deal with the above-described cut-out challenge (see FIG. 22A-G). 1. Acquiring single or multiple digital sources of the image 80, pictures, scanning, or drawing the image. 2. Using photo editing application, e.g. Photoshop, to process the digital source of the image into a light and a shadow image e.g. by applying a threshold filter. 3. Fine-tuning the threshold level parameters of the filter to get the desired light and shadow image 82. 4. Drawing the outline of all the “light” areas 84 of the light and shadow image 82 created in step 3 with a digital pen (see FIG. 22C). 5. After step 4, the outline image 86 (see FIG. 22D) very likely contains “light” area closed contours 84 and isolated shadow feature (“shadow islands” 88). For each “shadow island” 88, tune the threshold filter level higher until the specific “shadow island” 88 seems as if it is linked to either the image panel 12 or to another “shadow island” 88 or “shadow peninsula” 90.” Mark the first path detected as the preferred isthmus 92 of that particular “shadow island” 88 to the image panel 12. Repeat this procedure for each “shadow island” 88. The outcome is an outline drawing 94 (see FIG. 22F) contains closed contours 84 of all the “light” areas. 6. Editing the outline drawing of step 5 to link all the “shadow islands” to the panel body according to the paths revealed in step 4 by isthmus 92 until all the “shadow islands” 88 become “shadow peninsulas” 90. It is preferable to mark this isthmus 92 differently e.g. by different color, in order for the adjusting process to deal with them differently than with a regular “shadow islands” 88 as they are necessary evil and used merely to hold the “shadow islands” 88. Since these isthmuses 92 are not part of the image, they should be implemented with the minimum width possible depending on the strength of the material the image is supposed to be cut out therefrom and the constraint of the cut out technology to be used. 7. To create simulation of the image to be projected 24, bucket painting the panel 12 (“shadow” areas) of the outline drawing 94 in black by using photo editing application. If the result is poor, repeating steps 3-6 to find the next possible link. If the result is good, continue to step 8. 8. Saving the outline drawing 94 to an appropriate image format (e.g. vector format). The closed contours 84 are the areas to be cut-out. The outline drawing 94 could be further processed by the above and below described adjusting process or by being used as a digital input to Computer Numerical Control (CNC) machining, water jet cutting, plasma cutting, laser cutting, etching, etc. The output could also be used for fabricating a die or stamp, as well as printing drawings for manual cutting. Another embodiment of the cut out process is described in the cut-out process flowchart (FIG. 23).

A good artist with keen perception might be able to do part of the above process steps 1-4 manually, by drawing, illustrating, etc. Colors may be applied to the light-up areas of the image by covering the cut-out areas with colored transparent material such as cellophane, etc. Images on coins and medals are typically created by embossing or engraving. The embodiments described above suggest that adding a cut-out style will have the same appeal as standalone coins or medals. For example, in another embodiment, a coin or medal 23 may be replicated in the panel 12 by having the image cut-out therefrom, and projected on a wall or other object. Medals and coins 23 which are having image cut-out instead or in addition to embossed and engraved features (see FIG. 9C). These cut-out medals and coins will be aimed at the same market as regular medals and coins, but will have an additional feature. They can be placed on a special designed panel similar to the idea of the replaceable frame 21 in FIG. 2, and the cut out image on the medal could be projected onto a projection spot. For instance, a medal of Martin Luther King, which normally is placed in a stand on a cabinet or inside a display cabinet, on Martin Luther King Day, it can be placed on the candlelight image projecting apparatus to be projected for commemorating the day. The same panel can be used for other medals of dignitaries or even to project customized medals of loved ones, wedding day medal and etc.

The image adjusting process described above will now be described in greater detail. The magnification-adjusting process is desirable in providing a high degree of freedom to the designers to design the product in any shape and form. The designers can use this tool throughout the design process to spot problems and to examine whether a specific image could be implemented in particular design settings without making concession on image fidelity. The process performs the following tasks: 1. Adjusting the cut-out thickness: If the light rays are not completely perpendicular to the image panel, the cut out profile may block the light rays, as seen in FIG. 17B. The thicker the panel out of which the image is cut, and the smaller the angle of light rays approaching the panel, the more material must be cut out for a given feature. Adjusting the cut-out thickness adds to the cut-out image those areas that blocks the light rays that are not supposed to be blocked. 2. Adjusting magnification factors: Unless the geometry of the image panel is not flat and is parallel to the projection spot, magnification adjustment should preferably take place, which is derived from the location of the particular image point relative to the light source and the projection spot. 3. Adjusting the blurring effect: Minor adjustments can be made to reduce the blurring effects caused by the unfocused light source. This can be done by reducing the size of the light-up areas correspondingly to the light-ray angle approached them. This solution does not totally eliminate the blurring effect but enables an emphasis on the shadowed areas which enhance the image fidelity. 4. Spotting reflection areas: The system can spot and provide an alert when cut out profiles are likely to cause reflections.

The Image Adjusting process preferably sets up a scale model of all the components involved in the design: Light source; image panel; and the object upon which projection is made (projection spot). Taking into account all of the above factors, as well as the position and dimension of each component, the best projected image can be determined for a particular design setup. The process can be done manually or automatically using a software program residing on one or more computer-readable media installed on one or more computers and/or processors. The process inputs preferably include: 1. The image to be projected or the outline drawing 94 of the cut-out process. 2. The geometry of the projection spot (3D), its dimensions, and its relative position. 3. The geometry of the image panel (3D), its dimensions, and its relative position. 4. The flame or bulb or LED center point relative position and its descent path and length (if any). 5. The image material and the production process parameters (Laser, CNC, CAD/CAM, Printer, etc.).

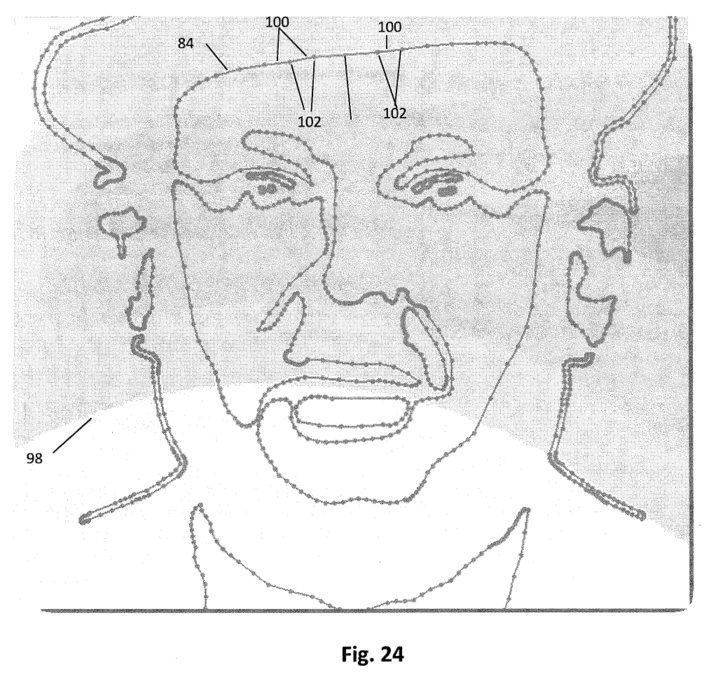

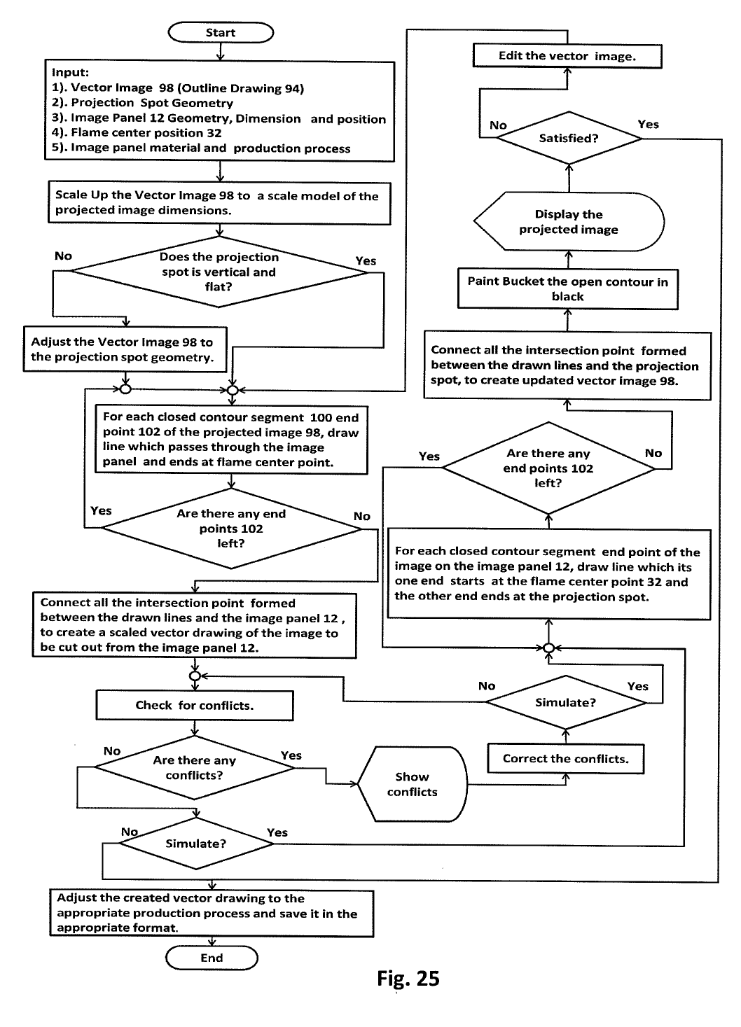

The process to be described below is merely one alternative for executing the preferred methods. Though the process can be performed literally by hand drawing or by computer-assisted drawing application, it can be performed by using various mathematical models (e.g. matrix, vector mathematics, geometry and etc.). A software application is used that makes use of mathematical models and vector graphics to fully automate the follows process. The Process preferably includes the following: 1. Scaling up the vector image 98 (e.g. outline drawing 94) to match a scale model that represent the real dimensions, as would appear on a flat vertical projection spot (see FIG. 24). The isthmuses 92 which link the “Isolated Islands” 88 to the panel 12 are kept marked differently (as described above) along the entire process. 2. Changing the vector scheme to a 3D model to fit the actual projection spot geometry. After this change, the vector image is supposed to look like the scaled image of step 1 by whoever stands opposite to the projection spot mid-point (This step does not applied if the projection spot is vertical and flat). 3. For every closed contour's segment 100 (vector) of the image on the projection spot, draw lines from vector's end points 102, which pass through the image panel 12 and meet at the flame's center point 32. 4. Magnification-Adjusting process: A reduced size projection of the 3D vector image of step 1 is derived by, correspondingly to the vector image, drawing lines connecting all the adjacent intersection points formed between the drawn lines and the 3D scale model of the image panel. The isthmus 92, which holds the “Isolated Islands” 88 are marked differently. 5. Thickness Adjusting Process: The formed image is adjusted to the panel thickness and material and, targeted implementation tooling (laser, CNC, CAD/CAM and etc.). The isthmus 92, which holds the “Isolated Islands” 88, as above described, are kept with minimum width possible considering the material and implementation tooling parameters. 6. The system alerts if there are conflicts with the implementation process (e.g. self intersect, thickness and etc.), and if so, it pin-points the conflicted points and may suggest modifications. 7. If no modification is needed, the process continuous to step 12 otherwise continue to next step. 8. Correction actions are been taken on the formed image to reflect the alerts. 9. A reverse process is possible to see how the modifications reflect on the projection spot. This is done by drawing lines from the flame's center point 32 through every vector's end points of the closed contours on the image formed to the projection spot. The projection spot vector image is derived from connecting all the intersection points of the drawn lines and the 3D scale model of the projection spot. A simulation of the actual image to be projected can be generated by bucket painting the panel (“shadow” areas) in black to receive a light and shadow image (see FIG. 22G). 10. The new projected image though can be modified again until satisfied result is achieved. 11. Process 3-10 can be performed iteratively up until a satisfied result is achieved. 12. An adjusted image for the predefined goal in the appropriate format is completed and ready to use. It can be used, but not only, as a digital input to CNC machining, water jet cutting, plasma cutting, laser cutting, etching, etc., it can be used for fabricating a die as well as a printing drawing for manual fabrications. 13. The software can pin point cut-out profiles which have the potential for light ray reflections. 14. The software can simulate the image at each point of the light source descended path. Another embodiment of the adjustment process is described in the adjustment process flowchart (see FIG. 25).

The individual components shown in outline or designated by blocks in the attached Drawings are all well-known in the injection molding arts (progressive die art, machining art, laser cutting art), and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. and foreign patents and patent applications discussed above are hereby incorporated by reference into the Detailed Description of the Preferred Embodiments.

What is claimed is:

1. A candlelight image projecting apparatus, comprising:
a panel having a shadow-producing image thereon; and
a base coupled to said panel and configured to hold a candle (i) spaced from said panel and (ii) such that a top of the candle flame is always below a top of the shadow image to cause a top of the shadow image to always be projected above the top of the panel.

2. Apparatus according to claim 1, wherein said base is configured so that the candle may be removed therefrom.

3. Apparatus according to claim 1, wherein said base is configured so that it is removable from said panel.

4. Apparatus according to claim 1, wherein said image comprises a cut-out in said panel.

5. Apparatus according to claim 1, wherein said image comprises an image disposed on a transparent or translucent frame replaceably mounted on said panel.

6. Apparatus according to claim 5, wherein said image is printed on the transparent or translucent frame.

7. Apparatus according to claim 1, further comprising a candle which is placed on said base.

8. Apparatus according to claim 7, wherein said candle comprises an artificial candle permanently attached to said base.

9. Apparatus according to claim 1, wherein said panel is curved in a horizontal direction.

10. Apparatus according to claim 1, wherein said panel is curved in a vertical direction.

11. Apparatus according to claim 9, wherein said panel comprises metal.

12. Apparatus according to claim 1, wherein said base includes structure configured to move a location of the candle.

13. Apparatus according to claim 1, wherein said panel has a plurality of shadow-producing images thereon.

14. A candlelight image projecting apparatus, comprising:
a panel having a shadow-producing image thereon; and
a base onto which said panel is mounted, said base configured to hold an outer surface of a candle from 1-3 inches from said panel and so that the top of a flame the candle is below a top of the shadow-producing image to cause an enlarged shadow to be projected upward from said panel.

15. Apparatus according to claim 14, wherein said base in configured to hold a battery-powered artificial candle.

16. Apparatus according to claim 14, wherein said panel comprises an opening with a detachable frame placed therein, and wherein said shadow-producing image comprises an image on a transparent or translucent material disposed on said frame.

17. Apparatus according to claim 16, wherein said shadow-producing image comprises an image printed on the transparent or translucent material.

18. Apparatus according to claim 14, wherein said panel is curved in a vertical direction.

19. Apparatus according to claim 14, wherein said images comprises a plurality of shadow peninsulas surrounded by light contours cut from a metal panel.

20. A method of projecting a candlelight image onto a surface, comprising:
providing a non-flammable panel having a shadow-producing image thereon;
disposing an outer surface of a candle on a base and at a distance from said panel; and
causing light to be projected from the candle in a manner to project a shadow of the image upward and enlarged onto a surface at a distance from said panel.
